(19) United States
(12) Patent Application Publication
(10) Pub. No.: US 2007/0171048 A1
(43) Pub. Date: Jul. 26, 2007

(54) Tracking system

(76) Inventor: Marshall Shapiro, Arlington Heights, IL (US)

Correspondence Address: SEYFARTH SHAW LLP, 131 S. DEARBORN ST., SUITE2400, CHICAGO, IL, 60603-5803, US

(21) Appl. No.: 11/487,046

(22) Filed: Jul. 13, 2006

Related U.S. Application Data
(60) Provisional application No. 60/698,696, filed on Jul. 13, 2005.

(51) Int. Cl. G08B 1/08

(52) U.S. Cl. 340/539.13

(57) ABSTRACT

A tracking device including a housing including a transceiver, a battery connected to the housing and an antenna connected to the housing, where the antenna is wrapped by at least one photovoltaic sheet and where the photovoltaic sheet is operable to recharge the battery. The tracking device includes a global positioning device, a radio frequency triangulation device and a microchip included in the housing. The tracking device also includes a microcontroller included in the housing, where the microcontroller is in communication with the battery, global positioning device, radio frequency triangulation device and microchip. The microcontroller is operable to cause the microchip to generate a position signal using the global positioning device and the radio frequency triangulation device to transmit the position signal via the transceiver and the antenna to enable user to detect a position of the tracking device.

### PRIORITY CLAIM

This application claims priority to and the benefit of U.S. Provisional Patent Application Ser. No. 60/698,696, filed Jul. 13, 2005, the entire contents of which are incorporated herein.

### BACKGROUND

The present invention relates to a RFID (Radio Frequency Identification) tracking system, and more particularly, to a chipset system and device to transmit and receive information over long distances, unlike conventional passive or reflective RFID technologies.

Current tracking systems designed for personnel, property, and animals are large bulky items for transmitting long distances. There are three categories of RFID technologies: Passive, Reflective, and Chipset. The first two passive and reflective technologies are micro or small in size but have a limited communication range of one meter to one hundred meters.

The passive system operates without a battery and will draw power from a localized reader within two meters. However, the minimal range of this system limits or constrains the location of where an object can be located and identified.

The reflective or active technology operates with a battery for short distances up to five meters. There are some devices that can transmit to five meters. The intent of this system is to be used indoors for asset tracking. An infrastructure is installed for readers or close proximity readers with in the specified range.

Such systems however are not adequate to address the growing personal security issues facing millions of people and their property.

In 2000, 85% to 90% of the 876,213 persons reported missing to America's law enforcement agencies were juveniles (persons under 18 years of age). That means that 2,100 times per day parents or primary care givers felt the disappearance was serious enough to call law enforcement. In fact, the disappearances of 152,265 of the missing people were categorized as being either endangered or involuntary. Unfortunately, the number of missing persons reported to law enforcement has increased from 154, 341 in 1982 to 876,213 in 2000. That is a rate of increase of 468% from 1982 to 2000.

Accordingly, attention to personal security and security of one's property has increased, especially keeping track of children. We all want to know what are teens are really doing.

People are also concerned about their personal property. There are millions of cars, trucks, vans and other motorized vehicles such as motorcycles that are owned by people. The desire to track such vehicles has increased due to theft. Many of these people also have pets such as cats and dogs which runaway, get lost or are stolen. Microchips are implanted in certain animals to retrieve the animal when it is found. However, implanted microchips do not allow a pet owner to track or locate an animal before it is found.

Accordingly, there is a need for a tracking system that minimizes the space needed for installation of the system, which can be equally and easily used for tracking people, pets, personal property and other objects, and can track the people, pets and objects at significant distances.

### SUMMARY

One embodiment of the present invention provides a tracking device including a housing including a transceiver, a battery connected to the housing and an antenna connected to the housing, where the antenna is wrapped by at least one photovoltaic sheet and where the photovoltaic sheet is operable to recharge the battery. The tracking device includes a global positioning device, a radio frequency triangulation device and a microchip included in the housing. The tracking device also includes a microcontroller included in the housing, where the microcontroller is in communication with the battery, global positioning device, radio frequency triangulation device and microchip. The microcontroller is operable to cause the microchip to generate a position signal using the global positioning device and the radio frequency triangulation device to transmit the position signal via the transceiver and the antenna to enable user to detect a position of the tracking device.

In an embodiment, the casing is wrapped in a photovoltaic sheet to provide a recharge to the tracking system when in a state of rest.

In an embodiment, the casing includes an antenna array.

In an embodiment, the casing includes an exterior skin that acts as a dual antenna including material to receive and transmit signals connected to a micro-transceiver.

In an embodiment, the casing is made of one of: a stainless steel or a plastic.

In an embodiment, the casing encloses said battery.

In an embodiment, the battery is a nine volt battery.

In an embodiment, the microchip is a combination of a transceiver and a GPS tracking system.

Another embodiment provides a tracking system for locating people, property, animals and other objects using a micro solar transceiver and casing system where the tracking system includes a casing including a battery for providing power that is recharged using at least one photovoltaic sheet wrapped around an antenna. The casing also including a micro controller, a GPS and RFT, a microchip, a transceiver and at least one power-flow regulator. The tracking system including at least one global satellite that acquires a location data of the microchip using the GPS and RFT and at least one cellular tower that receives the location data from the global satellite and transmits that location data to a user to identify the real time location of a person, an animal, property or an object.

In an embodiment, the tracking system includes a power flow regulator to control the flow of power to the system.

In an embodiment, the power flow regulator is a photovoltaic charging regulator.

In an embodiment, the tracking system includes an electronic containment system to keep objects within a designated area.

Another embodiment provides a method for tracking people, property, animals and other objects using a micro solar transceiver and casing system. The method includes providing a casing including a battery for providing power that is recharged using at least one photovoltaic sheet wrapped around an antenna, the casing also including a micro controller, a GPS and RFT, a microchip, a transceiver and at least one power-flow regulator. The method also includes associating the casing with a person, a piece of property, an animal or an object; determining the location of the person, piece of property, animal or object using at least one global satellite that acquires location data of the microchip using the GPS and RFT; and transmitting the location data to at least one cellular tower from the global satellite. The method includes transmitting the location data from the cellular tower to a user so that the user can identify the real time location of the person, the piece of property, the animal or the object.

In an embodiment, the method includes transmitting the location data from the cellular tower using a wireless device.

In an embodiment, the method includes causing the microchip to be in a dormant state, wherein in the dominate state, there is a hand off between one of more cellular towers that is received via server network, and by using this hand off technique software can triangulate location of the microchip.

In an embodiment, the method includes causing the microchip to be in a waken state, wherein the power is fully capable of transmitting long distances and the microchip can fully function by receiving and transmitting location data.

In an embodiment, the method includes transmitting the location data using a wireless device or tower.

In an embodiment, the method includes using the microchip for short periods of time such as 1 second to 30 seconds.

In an embodiment, the method includes signaling the microchip to remain in the wakened state for a designated period of time so that the microchip can be tracked for the designated period of time.

In an embodiment, the method includes determining if the person, property, animal or object breached a designated boundary.

Accordingly, an advantage is to provide a tracking system that can easily track a person, an animal, an object or property around the world.

Another advantage is to provide a tracking device that is not bulky and easy to carry and hide on a person, an animal, an object or on property.

Other objects, features and advantages of the invention will be apparent from the following detailed disclosure, taken in conjunction with the accompanying sheets of drawings, wherein like numerals refer to like parts, elements, components, steps and processes.

### BRIEF DESCRIPTION OF THE DRAWINGS

FIG. 1 is schematic view of a tracking device of one embodiment of the present invention.

FIG. 2 is a schematic view of a tracking system of one embodiment of the present invention.

FIG. 3 is a schematic view of an example of the tracking system being utilized to track a person.

### DETAILED DESCRIPTION

In consistency with identification systems or RFID, the device and system of the present invention is used to identify people, property an products enclosed in a micro solar containment system.

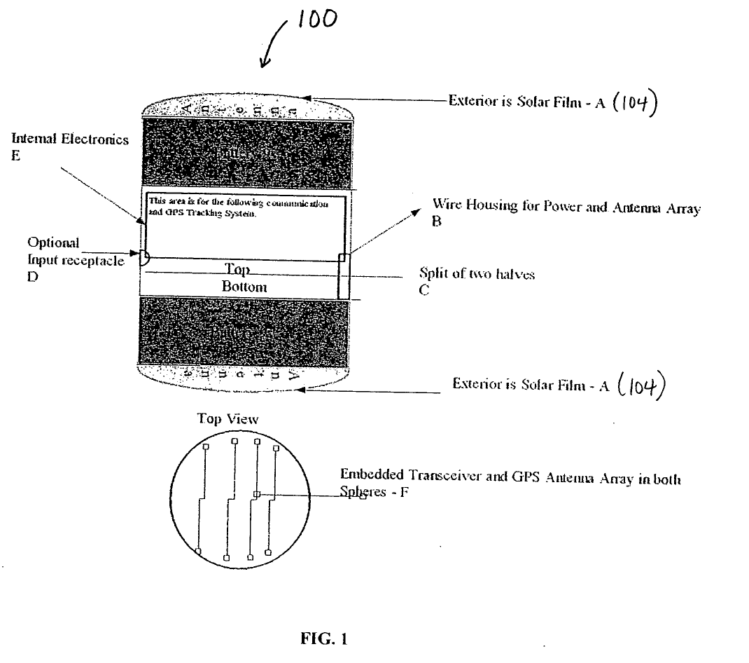

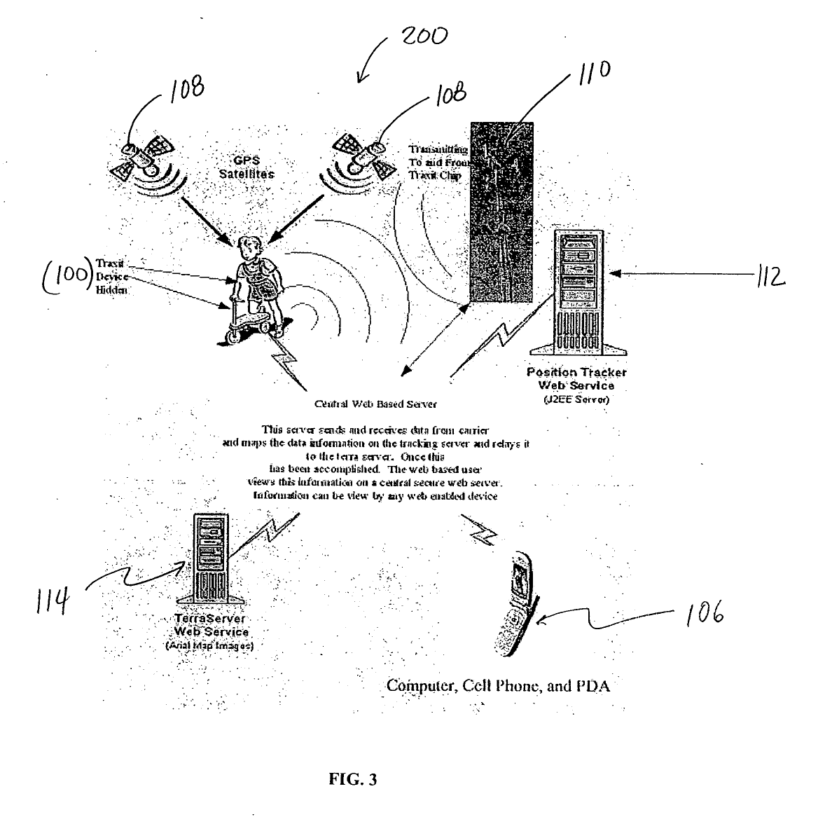

Referring to FIGS. 1-3, in an embodiment, a tracking device 100 lays in a state of rest, until a signal is received by the device to wake up. Once the device is woken up it acquires a signal by using a Global Positioning System (GPS), transmits the signal through a network, and then goes back into a state of rest.

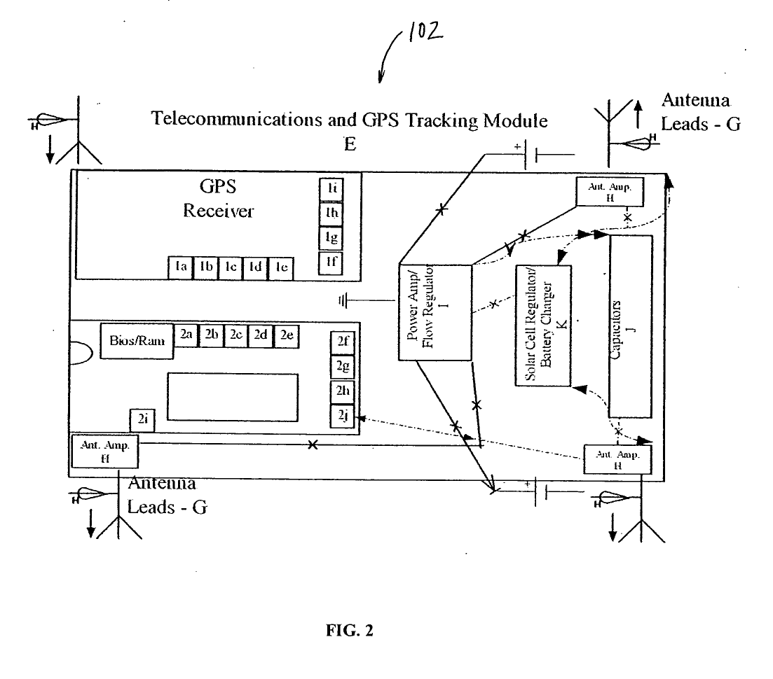

The tracking device 100 is used in a tracking or position system 200 illustrated in FIG. 2 and described in the paragraphs below. The tracking system 200 is designed to locate items either inside or outside of a building, structure or facility, or anywhere in the world. The design of the tracking device enhances the ability of the device to track a person or object within or outside of a building do to the low frequency of acquiring a signal. Using a low signal and low operating system is an a less expensive and affordable way to keep track of our most precious assets.

The tracking or position device, known as P3C, includes some general or main components. The device includes photovoltaic sheets 104 or wrapping that is an expensive and flexible film used to power low level operating devices. This film encloses a casing or housing of the device as describe below, and produces a 1.5-volt output per device, thus, creating a trickle charge to the battery. The sheet or film recharges the tracking device or system when in a state of rest. Power supplied by photovoltaic cells will continue to recharge the battery to full capacity through the a power regulator, which is connected to the film. The power supplied by the photovoltaic cells of the sheet continue to recharge a battery of the tracking device to full capacity through the power regulator. The power regulator determines full capacity and will discharge any additional or excess power. In an embodiment, the regulator is a photovoltaic charging regulator.

The power flow regulator is a device that regulates the flow of power within the tracking device. It has a relationship with the film, battery, and microchips. The power flow regulator determines if enough energy is being sent to a microprocessor of the device. It will also regulate the battery by making sure it is fully charged. If the battery is not charged, the power flow regulator draws power from the photovoltaic film. The battery is located within the casing to produce a maximum of 9v to produce enough energy to produce a signal for transmitting to a cellular network. This range at this battery level is from 1 meter to 10,000 meters.

The tracking system, position system or micro system allows any owner to track in real time the location of any person, property, object and the like.

The tracking system is a combination of a microchip and communication software that allows subscribers to locate anyone or anything that has the microchip. The user of this device can locate anything in any part of the world from any place in the world. The system is designed for low power and low signal operation.

In addition, users of the system can set perimeters and path deviation for tracking people, property and other objects. If the system is set in an electronic fence mode, an owner is notified by either phone (any phone), and email if the microchip or chip leaves the designated area. The user can quickly turn on the system using a web-enabled cellular telephone or a computer to locate that item or individual without going through a central monitoring station or the police departments.

Path deviation is the same as the electronic fence mode except that the user sets parameters on a specific course with a specific deviation of feet or other measuring criteria which is also set by the user.

There are two ways that the tracking device is engaged or activated from a remote location: Global Positioning System (GPS) 102 and Radio Frequency Triangulation (RFT). Both technologies are combined into a single tracking system to determine the location of a particular microchip. In an embodiment, the GPS and RFT technologies are contained or enclosed in a housing or casing such as a tamper-resistant housing, case or container. The casing is made of a stainless steal or hardened plastic to support the abuse associated with such a device. The system works by signing on to a website such as www.ITraxit.com, using a web-enabled device such as a cellular telephone or computer. Once the consumer decides which device to locate (if user has multiple devices), the software system contacts the designated microchip associated with that device and “asks” where the microchip is (i.e., determines the location of the microchip). The microchip provides coordinates as to its location by using the GPS satellite system. The coordinates are checked using the RFT. The location of the microchip and thereby the person, property or object, is mapped out onto a terra server, and the user is able to identify the location of the microchip by zooming in and out using the software.

The tracking system 200 can be used for a number of different purposes as described above such as tracking a child as shown in FIG. 1. The tracking device or chip 100 is carried or hidden on the child, in the child's clothing or on a bike or scooter that the child is using. A tracking server sends and receives data to and from the chip and maps the data (i.e., location information of the chip) on the tracking server. The mapped data is related to the terra server. A web-based user then views the location data or information on a central secure web server. The data or information can be viewed on any web-enabled device.

There are also many other uses for the tracking system such as tracking the real time location of disabled persons such as Alzheimer Patients; personal property such as cars, bicycles, motorcycles, jewelry and paintings; pets; military personnel; and other uses such as for medical uses and games. There are several uses for a tracking device of this type and the potential market is with out boundaries.

Thus, the tracking system and device of the present invention can be used to track people, property, animals or other objects. The system utilizes a micro-solar-transceiver-casing that uses the dual technology of a triangulation and global positioning system. The micro solar transceiver operates in conjunction with a dual antenna array to receive and broadcast coordinates of a microchip or chips using radio frequency for capture of the location data on a cellular network or other suitable network. The cellular network relays the coordinates to a teraserver and maps out the specific location for consumers, who can operate and utilize the system remotely such as from a computer at their home or office.

The microchip or micro chipset described above is a combination of cellular transceiver and a GPS tracking system. This micro communication device is used to communicate coordinates, and time only. Using radio frequency to a wireless or cellular network, this device can produce long-range communications with a cellular tower or server system.

In an embodiment, the operation of the tracking system is as follows:

1. Initially, the remote tracking device 100 is in a state of rest and in constant contact with a cellular network. The GPS system 102 is off.

2. A signal is sent by a user through a network system such as a computer or cellular telephone 106.

3. The tracking device is then woken and the GPS 102 is turned on.

4. The GPS system 102 receives a signal from one or more satellites 108 using a receiver antenna 110. The receiver antenna is located in any suitable location.

5. The tracking device 100 is sent time and location data from the satellite as an algorithm.

6. The GPS 102 converts the algorithm to specific coordinates.

7. Those coordinates are sent back through another antenna array.

8. The cellular server or network 112 receives the data and transmits the data to a server such as a terra server 114.

9. Mapping on the terra server 114 is then communicated to the user.

Generally, the operation of the tracking system includes providing a casing including a battery for providing power that is recharged using at least one photovoltaic sheet wrapped around an antenna, the casing also including a micro controller, a GPS and RFT, a microchip, a transceiver and at least one power-flow regulator; associating the casing with a person, a piece of property, an animal or an object; and determining the location of the person, piece of property, animal or object using at least one global satellite that acquires location data of the microchip using the GPS and RFT. The method also includes transmitting the location data to at least one cellular tower from the global satellite; and transmitting the location data from the cellular tower to a user so that the user can identify the real time location of the person, the piece of property, the animal or the object.

When the tracking device or microchip is in a dormant state there is a “hand off” between towers, this hands off technique is received via server network, and by using this hands off technique the software then can triangulate location. In the “dormant state” means that operation is not at higher commands other then low-level operations. Only when a signal is sent to waken the device will the device be able to function in full capacity by acquiring signals from GPS satellites and transmitting information.

In an embodiment, the microchip or chipset is identified by a unique code or phone number that is programmed at the factory or uploaded through the communication port on the device. This single or duel chipset design operates using very little battery power. In a state of rest, the power is used at less then 0.05 volts.

In the waken state, the power is fully capable of transmitting long distances, by operating in a waken state the tracking device can fully function by receiving and transmitting information. Unlike, in the dormant state where only the signal to turn on the device can be received.

In order for the device to wake from its dormant state, a signal needs to be sent via a wireless device or tower. The tracking device is used for shorts periods of time such as 1 second to 30 seconds. The device receives a signal to awaken, determines location, and then transmits the location. This entire operation will take seconds as mentioned above, and then go back to its dormant state.

In an embodiment, the process or method of tracking the tracking device or chip occurs for a designated period of time. The device receives a signal, and will be told to stay on for the designated period. The period of time will be determined by the user. The purpose of this function is for continually track an object or to determine if the object has breached (or left) certain boundaries or areas predetermined by the user. In this regard, the tracking system can be used to keep objects within certain area. The coordinates will be transmitted to device, and if device leaves the containment area, a call or email will be sent to the user of this device.

It should be appreciated that any suitable GPS or RFT device or system may be utilized to track a person or object. It should also be appreciated that the tracking device can by located in any suitable object or objects and may be any suitable size or shape.

While particular embodiments have been shown and described, it will be apparent to those skilled in the art that changes and modifications may be made without departing from the principles of the blower system in its broader aspects. The matter set forth in the foregoing description and accompanying drawings is offered by way of illustration only and not as a limitation.

1. A tracking device comprising:
a housing including a transceiver;
a battery connected to said housing, said battery adapted to provide power;
an antenna connected to said housing, said antenna wrapped by at least one photovoltaic sheet, wherein said photovoltaic sheet is operable to recharge the battery;
a global positioning device included in said housing;
a radio frequency triangulation device included in said housing;
a microchip included in said housing; and
a microcontroller included in said housing, wherein said microcontroller is in communication with said battery, global positioning device, radio frequency triangulation device and said microchip, said microcontroller operable to cause said microchip to generate a position signal using said global positioning device and said radio frequency triangulation device to transmit said position signal via said transceiver and said antenna to enable a user to detect a position of the tracking device.

2. The tracking device of claim 1, wherein said casing is wrapped in a photovoltaic sheet to provide a recharge to the tracking system when in a state of rest.

3. The tracking device of claim 1, wherein said casing includes an antenna array.

4. The tracking device of claim 1, wherein said casing includes an exterior skin that acts as a dual antenna including material to receive and transmit signals connected to a micro-transceiver.

5. The tracking device of claim 1, wherein said casing is made of one of: a stainless steel or a plastic.

6. The tracking device of claim 1, wherein said casing encloses said battery.

7. The tracking device of claim 1, wherein said battery is a nine volt battery.

8. The tracking device of claim 1, wherein the microchip is a combination of a transceiver and a GPS tracking system.

9. A tracking system for locating people, property, animals and other objects using a micro solar transceiver and casing system, said system comprising:
a casing including a battery for providing power that is recharged using at least one photovoltaic sheet wrapped around an antenna, the casing also including a micro controller, a GPS and RFT, a microchip, a transceiver and at least one power-flow regulator;
at least one global satellite that acquires a location data of the microchip using the GPS and RFT; and
at least one cellular tower that receives the location data from the global satellite and transmits that location data to a user to identify the real time location of a person, an animal, property or an object.

10. The tracking system of claim 9, which includes a power flow regulator to control the flow of power to the system.

11. The tracking system of claim 9, wherein the power flow regulator is a photovoltaic charging regulator.

12. The tracking system of claim 9, which includes an electronic containment system to keep objects within a designated area.

13. A method for tracking people, property, animals and other objects using a micro solar transceiver and casing system, said method comprising:
(a) providing a casing including a battery for providing power that is recharged using at least one photovoltaic sheet wrapped around an antenna, the casing also including a micro controller, a GPS and RFT, a microchip, a transceiver and at least one power-flow regulator;
(b) associating the casing with a person, a piece of property, an animal or an object;
(c) determining the location of the person, piece of property, animal or object using at least one global satellite that acquires location data of the microchip using the GPS and RFT; and
(d) transmitting the location data to at least one cellular tower from the global satellite; and
(e) transmitting the location data from the cellular tower to a user so that the user can identify the real time location of the person, the piece of property, the animal or the object.

14. The method of claim 13, which includes transmitting the location data from the cellular tower using a wireless device.

15. The method of claim 13, which includes causing the microchip to be in a dormant state, wherein in the dominate state there is a hand off between one of more cellular towers that is received via server network, and by using this hand off technique software can triangulate location of the microchip.

16. The method of claim 15, which includes causing the microchip to be in a waken state, wherein the power is fully capable of transmitting long distances and the microchip can fully function by receiving and transmitting location data.

17. The method of claim 13, which includes transmitting the location data using a wireless device or tower.

18. The method of claim 13, which includes mapping and displaying the location data on a website to a user.

19. The method of claim 13, which includes signaling the microchip to remain in the wakened state for a designated period of time so that the microchip can be tracked for said designated period of time.

20. The method of claim 19, which includes determining if the person, property, animal or object breached a designated boundary.
